(19) United States
(12) Patent Application Publication
(10) Pub. No.: US 2026/0352029 A1
(43) Pub. Date: Nov. 5, 2026

(54) A METHOD FOR WIRELESS POWER TRANSFER, A RELATED POWER TRANSFER ENHANCING DEVICE, AND A RELATED RADIO NETWORK NODE

(71) Applicant: Sony Group Corporation, Tokyo (JP)

(72) Inventors: Erik BENGTSSON, Eslöv (SE); Fredrik RUSEK, Eslöv (GB)

(21) Appl. No.: 19/485,571

(22) PCT Filed: May 21, 2024
(86) PCT No.: PCT/EP2024/063893

§ 371 Date: Nov. 18, 2025

(30) Foreign Application Priority Data
Jun. 2, 2023 (SE) 2350678-5
Sep. 8, 2023 (SE) 2351052-2

(51) Int. Cl. H02J 50/20; H02J 50/50; H02J 50/80

(52) U.S. Cl. CPC H02J 50/20; H02J 50/50; H02J 50/80

(57) ABSTRACT

Disclosed is a method, performed by a power transfer enhancing device, for wireless power transfer to a wireless device. The method comprises receiving, from a radio network node, a set of resources configured for power transfer to the wireless device. The method comprises transmitting a power transfer signal in the set of resources.

The present disclosure pertains to the field of wireless communications. The present disclosure relates to a method for wireless power transfer, a related power transfer enhancing device, and a related radio network node.

### BACKGROUND

In the 3rd Generation Partnership Project (3GPP) Ambient Internet of Things IoT refers to an ecosystem of objects, such as wireless devices (WDs), in which the objects may be connected into a wireless sensor network using self-powered sensor nodes and/or zero power-devices that harvest ambient energy. Such devices may be equipped with ultra-low power transceivers capable of harvesting energy from ambient/dedicated energy sources, such as wireless power transfer via radio frequency energy harvesting, to eliminate the need for recharging plugins and/or replacement batteries for these devices. With an increasing number of deployed wireless devices, such as Ambient IoT devices and/or zero power-devices, wireless power-transfer is becoming increasingly important. Typically, the power is transferred to the wireless devices from a radio network node. However, when deploying the Ambient IoT devices and/or zero power-devices at a cell edge of the radio network node the power received by the devices is typically weak.

### SUMMARY

Accordingly, there is a need for devices and methods for wireless power transfer to one or more wireless devices (WDs), which may mitigate, alleviate or address the shortcomings existing and may provide an increased power transfer to the WDs.

Disclosed is a method, performed by a power transfer enhancing device (PTED), for wireless power transfer to a wireless device. The method comprises receiving, from a radio network node, a set of resources configured for power transfer to the wireless device. The method comprises transmitting a power transfer signal in the set of resources.

Further, a power transfer enhancing device is provided. The power transfer enhancing device comprises memory circuitry, processor circuitry, and a wireless interface. The power transfer enhancing device is configured to perform any of the methods disclosed herein.

It is an advantage of the present disclosure that the PTED can be configured to operate as a local charge pump for transferring power to one or more wireless devices. By configuring the PTED to transfer power to a nearby WD, the distance over which the power has to be transferred can be reduced. Thereby, an efficiency, such as a coverage and/or a spectral efficiency and/or a temporal efficiency, of the power transfer can be increased, since the actual power can be delivered by the PTED rather than by the radio network node located further away from the WD.

Disclosed is a method, performed by a radio network node, for enabling wireless power transfer from a power transfer enhancing device to a wireless device. The method comprises transmitting, to the power transfer enhancing device, a set of resources configured for power transfer to the wireless device.

Further, a radio network node is provided. The radio network node comprises memory circuitry, processor circuitry, and a wireless interface. The radio network node is configured to perform any of the methods disclosed herein.

It is an advantage of the present disclosure that the radio network node can configure the PTED to operate as a local charge pump for transferring power to one or more wireless devices. By configuring the PTED to transfer power to a nearby WD, the distance over which the power has to be transferred can be reduced. Thereby, an efficiency, such as a coverage and/or a spectral efficiency and/or a temporal efficiency, of the power transfer can be increased, since the actual power can be delivered by the PTED rather than by the radio network node located further away from the WD.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example power transfer enhancing device, an example network node, and example wireless devices according to this disclosure,

FIG. 2 is a flow-chart illustrating an example method, performed by a power transfer enhancing device, for wireless power transfer to a wireless device according to this disclosure,

FIG. 3 is a flow-chart illustrating an example method, performed by a radio network node, for enabling wireless power transfer from a power transfer enhancing device to a wireless device, according to this disclosure,

FIG. 4 is a block diagram illustrating an example power transfer enhancing device according to this disclosure,

FIG. 5 is a block diagram illustrating an example radio network node according to this disclosure,

FIG. 6 is a signaling diagram illustrating an example communication between a power transfer enhancing device, a radio network node, and a wireless device according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

The figures are schematic and simplified for clarity, and they merely show details which aid understanding the disclosure, while other details have been left out. Throughout, the same reference numerals are used for identical or corresponding parts.

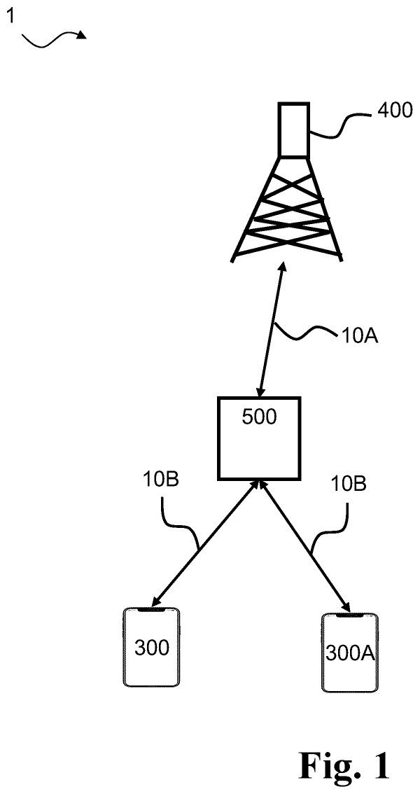

FIG. 1 is a diagram illustrating an example wireless communication system 1 comprising an example power transfer enhancing device (PTED) 500, an example radio network node 400 and one or more example wireless devices (WDs) 300, 300A according to this disclosure.

As discussed in detail herein, the present disclosure relates to a wireless communication system 1 comprising a cellular system, for example, a 3GPP wireless communication system.

The wireless communication system 1 comprises one or more of one or more wireless devices 300, 300A, one or more network nodes 400, and a PTED 500.

A radio network node disclosed herein refers to a radio access network, RAN, node operating in the radio access network, such as one or more of: a base station, BS, an evolved Node B, eNB, a gNB in NR, an access point, AP, and a small cell, SC. In one or more examples, the RAN node is a functional unit which may be distributed in several physical units.

A core network, CN, node disclosed herein refers to a network node operating in the core network, such as in the Evolved Packet Core Network, EPC, and/or a 5G Core Network, 5GC. Examples of CN nodes in EPC include a Mobility Management Entity, MME, and a Location Management Function, LMF.

A WD may herein refer to an energy harvesting device, such as one or more of a mobile device, a user equipment (UE), Internet of Things (IoT)-devices, such as Ambient IoT-devices, and low power devices with small batteries, such as zero-power devices. Depending on the power transfer capabilities of the PTED and/or the WD, the WD may also be a larger wireless devices, such as any powered device not connected to a power source.

The PTED 500 may be configured to communicate with the network node 400 via a wireless link (or radio access link) 10A. The PTED 500 may be configured to communicate with the wireless devices 300, 300A via a wireless link (or radio access link) 10B.

A PTED disclosed herein refers to a device configured to perform wireless power transfer, such as wireless power transfer to a WD. A PTED may refer to a coverage enhancing device (CED), such as a network controlled repeater (NCR) and/or any other form of relay device that is capable of providing data relay assistance in the network. In one or more example methods, any wireless device, such as a second WD, such as the second WD 300A, having appropriate hardware for power transfer, may act as the PTED. For a wireless device to act as the PTED may require that the wireless device is plugged in to a power supply, such as an electric socket, or is fully charged.

In wireless communications networks, the radio network node 400 may be configured to transfer power wirelessly to the one or more WDs 300, 300A. The wireless power transfer may be used for charging a battery of the one or more WDs 300, 300A. A limitation associated with the wireless power transfer from a radio network node to a WD may be the range from the radio network node in which it is feasible to perform a power transfer to the WD with sufficient efficiency. In general, the efficiency depends on the size of a transmit antenna of the radio network node, and the WD is typically required to be in a nearfield of the transmit antenna of the radio network node, so that the transmitted power can be focused towards a receive antenna of the WD. This poses a challenge when deploying Ambient Internet of Things (IoT) devices and/or zero power-devices at a cell edge of the radio network node where the power may be weak. Ambient IoT refers to an ecosystem of objects, such as WDs, in which the objects may be connected into a wireless sensor network using self-powered sensor nodes.

According to the current disclosure, a solution is provided where a PTED, such as the PTED 500 in FIG. 1, may be operated as a local charge pump for enhancing the range of the energy transfer. In contrast to conveying information, transferring power is typically only performed in down-link (DL), such as towards the one or more WDs. However, according to the current disclosure, the power transfer may also be performed in sidelink, such as via a PC5 interface or via a dedicated interface for power transmission in sidelink, between two WDs 300, 300A. In other words, in one or more examples of the current disclosure, the PTED 500 may be a second WD, such as the WD 300A when transferring power to the first WD 300. In other words, wireless power transfer from the PTED 500 to the one or more WDs 300, 300A is provided. Since the PTED 500 may be arranged between the radio network node 400 and the one or more WDs 300, 300A, the PTED 500 is arranged closer to the one or more WDs 30, 300A. Thereby, the efficiency of the power transfer can be significantly enhanced since the actual power can be delivered by the PTED 500 rather than by the radio network node 400 located further away. To achieve this, a link 10A, 10B may be established between the radio network node 400 and the WD 300, 300A via the PTED 500. During operation, a signal transmitted in resources associated with the power transfer may be generated or power boosted, such as amplified, by the PTED 500. The generated and/or power boosted signal may herein be referred to as a power transfer signal.

In one or more examples herein, the PTED 500 may be configured with a first link 10A towards the radio network node 400 and a second link 10B towards the one or more WDs 300. The configuration of the first link and second link may, in one or more example methods, be based on legacy procedures or enhanced procedures for ensuring nearfield beam optimization on an access side and/or a backhaul side.

In one or more example methods disclosed herein, the power transfer protocol between the one or more WDs 300, 300A and the radio network node 400, such as the protocol part that prepares both the radio network node and the WD for power transfer, is transparent to the PTED.

In one or more example methods, such as when the link, such as a beam, for power transfer has been configured, the PTED 500 is further configured to amplify a signal, such as a waveform, generated by the radio network node 400 and received by the PTED 500 (such as a waveform configured for, such as optimized for, power transfer). Amplifying the signal can herein be seen as applying a higher gain to the signal. The network node 400 may transmit the signal, such as the waveform with a lower power than required for wireless power transfer to the WD, as there is no need to transfer power from the radio network node 400 to the PTED 500. The PTED 500 then amplifies the signal and transmits the amplified signal for transferring power to the one or more WDs 300, 300A. In this case, the PTED may be transparently configured with resources, such as time and frequency resources, in which the PTED 500 is to amplify the signal, such as apply high gain. The PTED 500 being transparently configured with resources can be seen as the PTED 500 being configured to amplify and retransmit the signal received from the radio network node in a subsequent resource to the resource in which the signal was received. The amplified signal may thus be transmitted by the PTED 500 upon receiving the signal from the radio network node 400. The PTED 500 may thus not be configured with specific resources for transmission of a power transfer signal, instead the retransmission may be triggered by reception of the signal from the radio network node and the PTED 500 may be configured to retransmit the signal in one or more subsequent resources to the resource in which the signal is received.

In one or more example methods disclosed herein, such as when the link, such as a beam, for power transfer has been configured, the PTED 500 may be configured with resources, such as time/frequency resources, on which to apply a self-generated signal, such as a waveform, for power transfer, herein referred to as a power transfer signal. The PTED 500 may generate the signal, such as the waveform, for power transfer in the indicated resources. Configuring the PTED 500 to generate the power transfer signal allows the PTED 500 to turn off a receiver, since it doesn't have to receive a signal to amplify, and thus allows for a much higher power level to be applied to the power transfer level. The possible gain in the PTED 500 may otherwise be limited by an isolation, such as a port-to-port isolation, between a receiving antenna port and a transmitting antenna port. The port-to-port isolation can be seen as a ratio between a power fed into one port of an antenna to the power received at another port of the antenna. Ideally, it is desired that two ports are completely independent, such as have an infinite isolation, because then a signal transmitted or received on one port of the antenna will not interfere with a signal transmitted or received on the other port of the antenna. The lower the isolation, the more interference there may be between the two signals. In case the gain is larger than the isolation, the ports, such as the signals transmitted and/or received on the ports may start to self-resonate. By turning off the receiver, such as by ceasing to receive signals, the gain of the power transfer signal may be increased which increases the power level of the power transfer signal.

In one or more example methods, the PTED may be configured to convey information, such as data, in resources not associated with power transfer.

In order to provide an efficient wireless power transfer from the PTED 500 to the one or more WDs 300, 300A, an increased power density is desired. The efficiency of the wireless power transfer increases with the power density. However, a maximum allowable power density of a channel may be governed by regulations, which restricts the allowable power density to protect biological tissue, such as humans, from being exposed to harmful power levels. However, a higher maximum power density may be allowable if it can be guaranteed that the vicinity of the system is free from humans or any other biological tissue.

According to one or more example methods of the current disclosure, the PTED may check, prior to an activation of the wireless power transfer, that there are no objects, such as humans, present close to the PTED, such as between the PTED and the wireless device.

In one or more example methods the PTED may check the vicinity by determining a strength and/or efficiency of a wireless power transfer link, such as whether the WD is in close enough proximity and there is no blocking between the PTED and the WD. The strength of the wireless power transfer link may be measured by legacy channel estimation procedures. The legacy channel estimation procedures may be performed continuously or occasionally during the wireless power transfer to ensure the strength and/or efficiency and detect possible changes wireless power transfer link.

In one or more example methods, the PTED may check its vicinity, such as determine the strength and/or efficiency of the wireless power transfer link, by transmitting a probing signal, such as performing a probing signal sweep, to ensure that there are no humans and/or objects in the vicinity of the power transfer link.

A probing signal may herein also be referred to as a Radio Detection and Ranging (RADAR) sweep, a RADAR probe, or a RADAR pulse. A probing signal may comprise a short burst of electromagnetic radiation that is transmitted to gather information about its surrounding environment, such as an object to be sensed. A probing signal may be seen as a radio frequency electromagnetic signal. A probing signal may be used to detect and locate objects, as well as to measure their properties such as distance, speed, direction, shape, and/or composition.

In one or more example methods according to the current disclosure, the transmission of the probing signal, such as the RADAR sweep, is performed as a remote sweep from a radio network node, for example by the radio network node transmitting the probing signal. In one or more example methods, the PTED may be configured with different beam configurations and/or may be operated in full duplex mode, so that a probing signal transmitted by the radio network node and reflected by the PTED can be fed back to the radio network node.

A capability to be operated in, such as support, full duplex mode may indicate whether the PTED is capable of transmitting and receiving on both a back-haul link (toward the radio network node) and toward an access side (e.g., the target for the beam sweep, such as the object, such as the WD). In other words, a capability to support full duplex mode may indicate whether the PTED is capable of transmitting and receiving on both a back-haul link and toward an access side simultaneously. In general, full duplex mode operation may be challenging as there needs to be high isolation between the receiving (Rx) and transmitting (Tx) ports. Today, full duplex mode is being standardized for the radio network node side only. For the radio network node side it may be possible to allow full duplex mode with port isolation achieved with physical separation of the Rx and Tx antennas. It may also be possible for the wireless device and the PTED to allow full duplex mode with port isolation achieved with physical separation of the Rx and Tx antennas or by time gating, such as by configuring reception and transmission in non-overlapping time resources.

In one or more example methods according to the current disclosure, the transmission of the probing signals, such as the RADAR sweep, is performed autonomously by the PTED. Performed autonomously can herein be seen as the PTED both generating, such as transmitting, and detecting the probing signal, such as the RADAR signal. In one or more example methods, the PTED sends a report, such as a measurement report, based on the detected probing signal, to the radio network node. The report based on the probing signal may herein be referred to as a probing report or RADAR report. In one or more example methods, the report may be and/or comprise a single bit indicating, for example that it is “ok to perform wireless power transfer” based on that the environment is static (such as when no changes are detected), or that it is “not ok to perform wireless power transfer” based on that the environment is variable (such as when changes are detected). In one or more example methods, the report may be a full report comprising measurement values measured on the probing signal, such as measured Doppler, delays etc. for each beam.

In one or more example methods, the PTED is configured with resources dedicated for the probing signal, such as the probing sweep. The dedicated resources for probing signals may be configured by the PTED receiving a resource configuration for probing signals from the radio network node. Different details may be included in the reporting of the results of the probing signal sweeps, for example based on a capability of the PTED. To effectively use scarce spectrum resources, the PTED may be configured to transmit a first full probing report, and later-on, only report if there are substantial changes in a probing based measurement, such as in a measured RADAR image. The radio network node may activate and/or deactivate the wireless power transfer performed by the PTED based on the one or more reports, such as the probing reports, received from the PTED, for example by transmitting an activation and/or deactivation message to the PTED. For example, if the report, such as the probing report, comprises information indicating that it is “ok to perform wireless power transfer”, then the radio network node may activate the wireless power transfer from the PTED, for example by sending an activation message to the PTED. In one or more examples, if the report, such as the probing report, comprises information indicating that it is “not ok to perform wireless power transfer”, then the radio network node may deactivate the wireless power transfer from the PTED, for example by sending a deactivation message to the PTED.

In one or more example methods, the PTED autonomously evaluates a probing image, such as a RADAR image, obtained based on the probing sweep. The PTED may be configured to perform wireless power transfer only in case there are no probing echoes, such as reflections of the probing sweep, from objects within a specified range (with exception of the direction of the intended wireless power transfer as the object receiving the power transfer will provide a probing echoe in that direction), and simultaneously that there are no changes (within the same range) in the probing image for a certain time-period (i.e., a static environment). In one or more example methods, the radio network node simultaneously measures the channel conditions for the wireless power transfer to the wireless device, such as to the target wireless device, and can detect possible changes also on this link.

In one or more example methods, upon the probing showing that there are objects in directions other than the intended direction, high power should not be transferred in the intended direction of the energy transfer. This is due to safety reasons, since sidelobes of the power transmit beam may exist that may reach these objects.

In one or more example methods, the PTED may not perform the power transfer, such as operate in a high power operational mode, may not be performed upon the probing showing that there are further objects in the intended direction of power transfer. Further objects in the intended direction of power transfer may herein refer to objects not being at the same distance as the intended object for power transfer, such as objects being located closer to the PTED than the intended object for power transfer.

In one or more example methods, the wireless device may be configured for wireless power transfer. In one or more example methods, the wireless device may apply further safety mechanisms associated with wireless power transfer, such as channel sensing (e.g., Radio Frequency (RF) based and/or IMU based) to determine that it is not in proximity to a user. The WD may transmit a signal, such as a channel sensing report, to the PTED and/or the radio network node, indicating whether it is safe to perform a wireless power transfer to the WD.

In one or more example methods, the PTED may be configured, for example by the radio network node, with a probing sweep, such as a remote autonomous probing sweep. In other words, the PTED may receive from the radio network node, a configuration message configuring the PTED to perform a probing sweep. In one or more examples, the configured probing sweep may be associated with a criterion for a further operation. The further operation of the PTED may, in one or more examples, be a wireless power transfer and/or a high power operational mode.

In one or more example methods, the criterion comprises a range, such as a maximum distance from an object. The range can herein be seen as a range, such as a distance, from the PTED to the object. In one or more example methods, the range may stipulate a maximum distance between the PTED and the object that has to be met before the further operation may be performed.

In one or more example methods, the range has an exception associated with a beam configuration which is associated with the further operation, such as with the wireless power transfer and/or the high power operational mode. The beam configuration may be associated with a near field beam, such as may indicate that the further operation is to be performed with the near field beam. In other words, the PTED may be configured to transmit with a further range in the direction of the WD that is to receive the power transfer. In one or more example methods, the criterion comprises a time, such as a time duration. The time duration may be associated with the further operation. In one or more example methods, the time may indicate a time the probing image has to be static before the further operation can be performed, and/or a duration of further operation, such as a time duration during which the power transfer and/or high power mode is to be activated.

In one or more example methods, the criterion comprises a reporting configuration. The reporting configuration may indicate how and/or when the PTED is to transmit the probing report, and/or what information the reporting configuration is to comprise. In one or more example methods, the reporting configuration may indicate whether the PTED is to receive an acknowledgement (ACK) from the radio network node prior to performing the further operation.

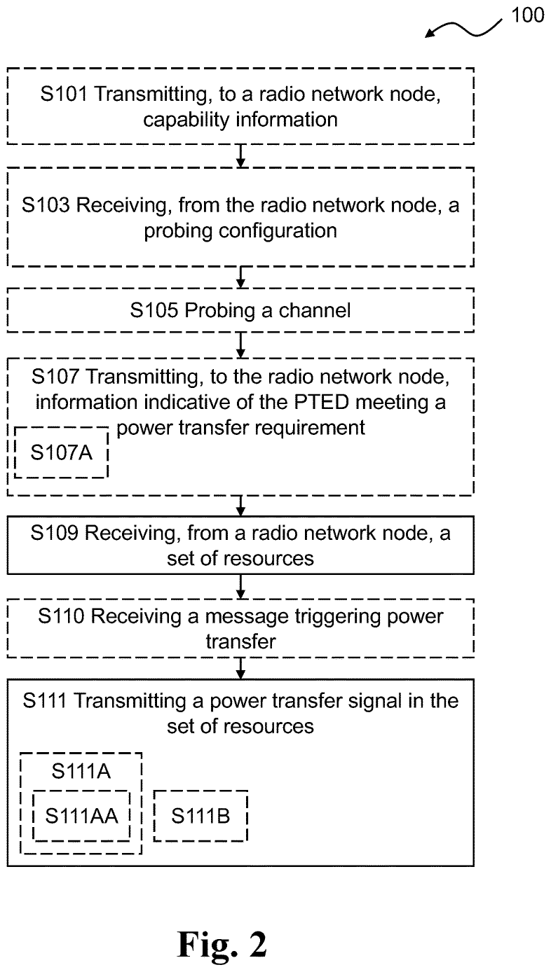

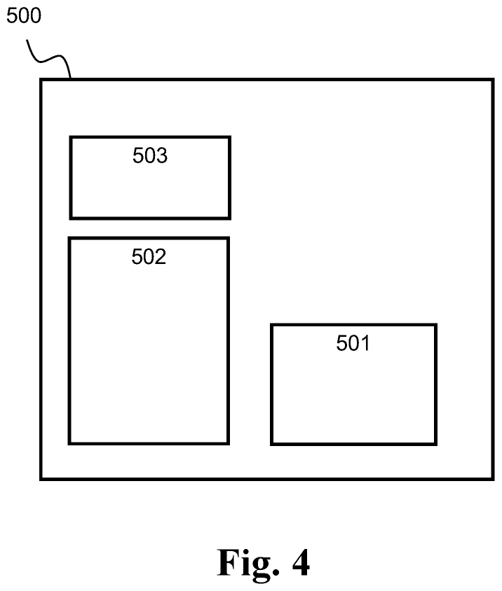

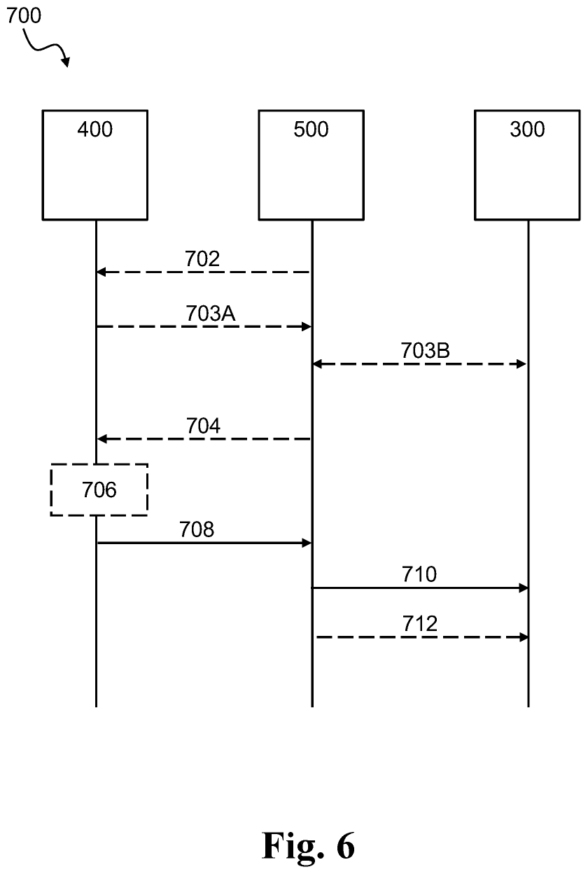

FIG. 2 shows a flow-chart of an example method 100, performed by a power transfer enhancing device (PTED) according to this disclosure, for wireless power transfer to a wireless device (WD), such as a first WD. The PTED is the PTED disclosed herein, such as PTED 500 of FIG. 1, FIG. 4, and FIG. 6. The PTED may be any device capable of wireless power transfer. In one or more example methods, the PTED is a legacy coverage enhancing device (CED), such as a CED configured to relay communication between one or more WDs and/or radio network node(s), or a dedicated power transfer CED, such as a CED being configured, such as solely configured, for wireless power transfer. The dedicated power transfer CED may, in one or more example methods, be a power transfer relay device positioned between the WD and a radio network node, preferably closer to, such as in the nearfield of, the WD. In one or more example methods, the PTED may be a second WD different to the first WD.

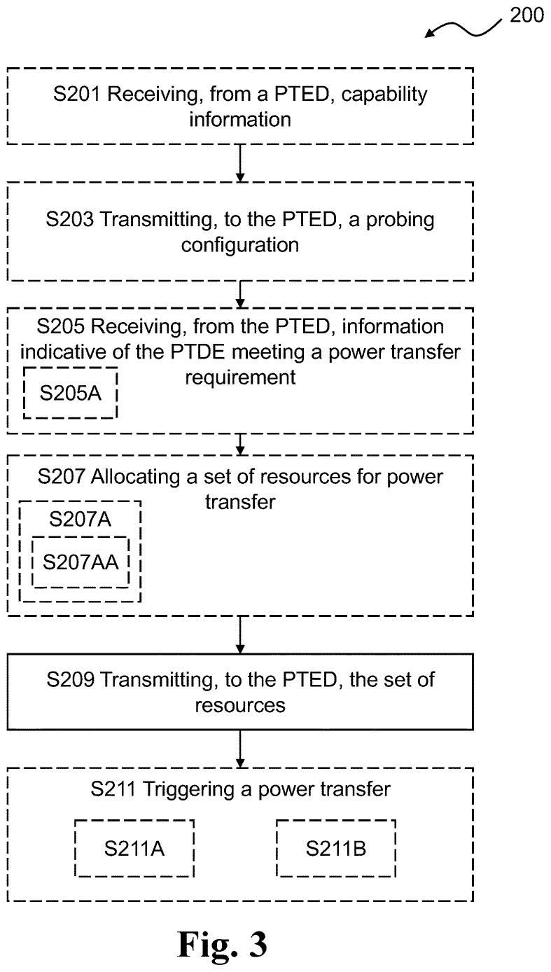

In one or more example methods, the method 100 comprises transmitting S101, to the radio network node, capability information indicative of the PTED's capability to wirelessly transfer power to one or more WD(s). The one or more WD(s) may comprise the first WD and one or more second WD(s). The capability information may for example be indicative of one or more of the PTED being plugged into an electrical connection, the PTED being capable of forming a beam for power transfer, and/or the PTED being capable of amplifying a received signal and/or generating a power transfer signal. In one or more example methods, the capability signaling may be indicative of the PTED being capable of ceasing to receive, such as turning off a receiver, during power transfer, such as during transmission of a power signal. The capability to cease receiving may be indicated in the capability signalling as one or more delays associated with turning on/off the receiver at the PTED and/or entering/exiting a high power mode. In one or more example methods, the high power mode may be a higher power mode than allowed by regulations in the vicinity of biological tissue, such as humans or animals. In confined spaces and/or when there is no biological tissue in the vicinity of the PTED, the allowed power may be increased. The capability information can herein be seen as a general capability of the PTED to wirelessly transfer power to one or more WDs. Transmitting S101 corresponds to receiving S201 of FIG. 3 and the capability signaling 702 of FIG. 7.

In one or more example methods, the method comprises receiving S103, from the radio network node, a probing configuration for probing a channel, such as a power transfer channel. The probing configuration may comprise an information indicative of a probing sweep, such as a probing sweep, to be performed by the PTED. The probing configuration may, in one or more example methods be indicative of resources, such as time and/or frequency resources, dedicated for the probing signal, such as the probing sweep. The configuration may, in one or more example methods, comprise information configuring the PTED to perform a remote and/or autonomous probing sweep. Autonomously performing can herein be seen as the PTED generating, such as transmitting, and detecting the probing signal. The probing configuration may, in one or more example methods, comprise a criterion for a further operation, such as a wireless power transfer and/or a high power operational mode. The criterion may be a criterion for when the further operation is to be performed.

In one or more example methods, the criterion comprises a range, such as a maximum distance. The range can herein be seen as a range, such as a distance, from the PTED to the WD. In one or more example methods, the range has an exception associated with a beam configuration which is associated with the further operation, such as with the wireless power transfer and/or the high power operational mode. The beam configuration may be associated with a near field beam, such as may indicate that the further operation is to be performed with the near field beam. In other words, the PTED may be configured to transmit wireless power and/or with the high power operational mode, when the WD is within the indicated range. In one or more example methods, the criterion comprises a time, such as a time duration. The time duration may be associated with the further operation. In one or more example methods, the time may indicate a time the probing image has to be static before the further operation can be performed, and/or a duration of further operation, such as a time duration during which the power transfer and/or high power mode is to be activated.

In one or more example methods, the criterion comprises a reporting configuration. The reporting configuration may indicate how and/or when the PTED is to transmit the probing report, and/or what information the reporting configuration is to comprise. In one or more example methods, the reporting configuration may indicate whether the PTED is to receive an acknowledgement (ACK) from the radio network node prior to performing the further operation.

In one or more example methods, the method comprises probing S105 a channel, to determine whether there are objects, such as biological tissue, such as humans, present close to the PTED, such as between the PTED and the wireless device. The probing may be performed for example by transmitting a probing signal, such as performing a probing sweep, such as a RADAR sweep. The PTED may probe the channel to be used for power transfer, such as a channel to the WD that is to receive wireless power transfer, based on the received probing configuration. In one or more example methods, the probing signal may be a signal transmitted by the radio network node and reflected by the PTED. The PTED may, in one or more example methods be configured for full duplex operation, so that the PTED can transmit and receive on both a back-haul link and toward an access side simultaneously. This allows the probing signal transmitted by the radio network node and reflected by the PTED can be fed back to the radio network node.

In one or more example methods, the method 100 comprises transmitting S107, to the radio network node, information indicative of the PTED meeting a power transfer requirement for transferring power to the WD. The information indicative of the PTED meeting a power transfer requirement for transferring power to the WD can herein be seen as a capability of the PTED to transfer power to a specific WD in the wireless communication network. In one or more example methods, the information indicative of the PTED meeting the power transfer requirement may be indicative of a beam configuration for power transfer to the WD. The PTED may for example transmit information indicative of a beam configuration of the PTED meeting the power transfer requirement. In one or more example methods, the information indicative of the PTED meeting the power transfer requirement may be indicative of a relative position between the WD and the PTED, such as the WD being within a predetermined distance of the PTED. In one or more example methods, the information indicative of the PTED meeting the power transfer requirement may be indicative of the WD being in Line-of-Sight (LOS) of the PTED. In one or more example methods, the information indicative of the PTED meeting the power transfer requirement may be indicative of a power measurement, such as a power measurement meeting a power transfer requirement for transferring power. In one or more example methods, the PTED may perform a beam sweep with the WD and determine whether the beam configuration meets one or more power transfer requirement(s), such as a Received Signal Strength Indicator (RSSI) meeting an RSSI requirement, and/or a Signal-to-Noise ratio (SNR) meeting an SNR requirement. The RSSI requirement may for example be met when the RSSI is equal to or above an RSSI threshold. The SNR requirement may for example be met when the SNR is equal to or above an SNR threshold. The information indicative of the PTED meeting the power transfer requirement may thus, in one or more example methods, be indicative of one or more of the RSSI meeting the RSSI requirement and/or the SNR meeting the SNR requirement. The power transfer requirement may be determined by the radio network node. In one or more example methods, transmitting S107 information indicative of the PTED meeting a power transfer requirement for transferring power to the WD comprises transmitting S107A one or more probing reports. The one or more probing reports may comprise information indicative of the probing result, such as information indicative of whether there are objects present in the vicinity of the PTED. The one or more probing reports may comprise different details of the probing signal sweeps, for example based on a capability of the PTED. To effectively use scarce spectrum resources, the PTED may transmit a first full probing report, and later-on, only report if there are substantial changes in a probing based measurement, such as in a measured probing image. In one or more example methods, the one or more probing reports comprise information indicating that it is “ok to perform wireless power transfer”, such as the probing meeting a probing criterion for transferring power to the WD. In one or more examples, upon the probing being indicative of objects in the vicinity of the PTED, the probing report may comprise information indicating that it is “not ok to perform wireless power transfer”, such as the probing criterion not being met. In one or more example methods, the probing criterion may be that there are no objects within a certain range from the PTED, for example in the direction of the WD to receive the power transfer, and/or that the probing image has not changed for a certain time-period.

Transmitting S107 corresponds to receiving S202 of FIG. 3 and the capability signaling S702 of FIG. 7.

In one or more example methods, the PTED may obtain a position of the WD, determined for example via 3GPP positioning procedures and/or via a global navigation satellite system (GNSS), and may compare the position with stored information, such as a look-up table, to determine whether the PTED meets the power transfer requirements for transferring power to the location of the WD.

In one or more example methods, the information indicative of the PTED meeting the power transfer requirement is explicitly signaled, for example by indicating the actual value of the measurements, or by indicating the beam configuration to be used for power transfer. In one or more example methods, the information indicative of the PTED meeting the power transfer requirement is implicitly signaled, for example by transmitting an acknowledgement (ACK) being indicative of the requirements being met.

In one or more example methods, the PTED may determine, based on a received power transfer requirement, whether the power transfer requirement is met or not.

In one or more example methods, the PTED may transmit the information, such as measurement results and available beam configurations, to the radio network node, and the radio network node may determine whether the PTED meets the power transfer requirements. This corresponds to the determining S203A of FIG. 4.

The method 100 comprises receiving S109, from the radio network node, a set of resources configured for power transfer to the WD. In one or more example methods, receiving S109 the message comprises receiving S109B, from the radio network node, upon the probing report being indicative of the probing criterion being met, an ACK for power transfer to the WD. The set of resources and/or the ACK may be comprised in the message, such as in a same or in different messages. Receiving S109A the set of resources corresponds to transmitting S205 of FIG. 3 and the set of resources 708 transmitted by the radio network node 400 in FIG. 6.

In one or more example methods, the method 100 comprises receiving S110, from the radio network node, a message triggering a power transfer, such as a message indicating that the PTED is to transfer power to the WD. In one or more example methods, the message triggering power transfer may be received in response to the probing message being indicative of the probing criterion being met.

The method 100 comprises transmitting S111 a power transfer signal in the set of resources. In one or more example methods, transmitting may be performed upon receiving the ACK from the radio network node. In one or more example methods, the power transfer signal is a signal having characteristics, such as a waveform, for power transfer. In one or more example methods, the power transfer signal is a signal without any embedded information. Transmitting S111 the power signal corresponds to the power signal 710 transmitted by the PTED in FIG. 6.

A WD's energy harvesting capability may not be linear in its received power. The efficiency of the power transfer may be much higher for signals having large power values compared with signals having small power values due to characteristics of diodes used within the WD. Therefore, if a signal is peaky, so that it contains many small power values and many large power values, then the small values cannot be used by the WD for power transfer.

Different energy harvesting wireless devices may have different implementations and therefore characteristics. For illustrative purposes, a non-linear behavior of harvested power P, such as the received power, at the WD as a function of an input power X, such as the power received at the WD, may be simplified into P=max(0, X−T), where T is a threshold between small and large signals. In other words, signals having a power lower than the threshold may be seen as small signals and signals having a power being equal to or above the threshold may be seen as large signals.

With the above simplified model, yet rich enough to capture essential energy harvesting properties of realistic devices, to provide a fixed transmit energy E in the power transfer signal, the power transfer signal may ideally be formed as a single spike containing all the energy E and being zero everywhere else. This may however lead to other problems, such as a power amplifier (PA) at the transmitter saturating, causing a Peak to Average Power Ratio (PAPR) problem, and a huge backoff n power may be required.

Therefore, in one or more example methods, the power transfer signal is formed to comprise, such as have a waveform comprising, an energy E being constant at a saturation level of a power amplifier (PA) of the PTED, and zero everywhere else. Signal samples having less power than T of the power transfer signal, may be relocated to another signal sample, to improve the power transfer via the power transfer signal. Thereby, a saturation of the PA at the PTED may be avoided.

In one or more example methods, the power transfer signal is transmitted using a dedicated operational mode of the PTED, such as a wireless power transfer mode of the PTED. The dedicated operational mode, such as the power transfer mode, may be a mode enabling the PTED to transmit with a higher power than used for communication of data. The dedicated operational mode may be a high power and/or high gain mode.

In one or more example methods, transmitting S111 comprises generating S111A the power transfer signal. The power transfer signal may be generated using a pre-determined or pre-configured waveform for wireless power transfer. The PTED may, in one or more example methods, generate the power transfer signal without receiving a signal to amplify from the radio network node. In one or more example methods, generating S105A the signal comprises ceasing S105AA to relay a signal received at a receiver of the PTED, such as a second signal, to increase the power level of the transmitted power transfer signal. By ceasing to relay signals received at the receiver of the PTED when generating the power transfer signal, a higher power may be used to transmit the power transfer signal. Reason for this is that the possible power generated in the PTED may be limited by an isolation between receiving antenna ports and transmitting antenna ports of the PTED, and if the transmit power is larger than the isolation, the PTED may start to self-resonate. In one or more example methods, the PTED may cease to relay the signals received at the receiver of the PTED upon entering the dedicated operational mode for transmitting the power transfer signal.

In one or more example methods, transmitting S111 the power transfer signal comprises amplifying S111B a signal received from the radio network node. Amplifying can herein be seen as increasing the gain of the signal. In other words, the power transfer signal may be transmitted using a higher power than the power of the signal received from the radio network node. In one or more example methods, the signal received from the radio network node is a dedicated power transfer signal, such as a signal having a dedicated waveform for power transfer. However, in one or more example methods, the PTED may amplify any signal received from the radio network node, such as a data signal.

In one or more example methods, transmitting S111 the power transfer signal is performed upon receiving a trigger from the radio network node. In one or more example methods, the trigger is inferred from scheduling of the resources for transmission of the power transfer signal. In one or more example methods, the resources may be periodic and actively triggered by the radio network node when power transfer is required. The trigger may be one or more of a reception of a signal to amplify or a reception of a message comprising an indication indicating to the PTED to transmit the power transfer signal, such as a message comprising an ACK.

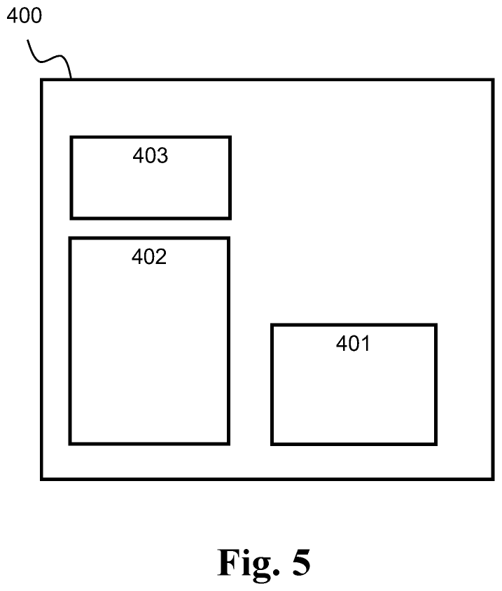

FIG. 3 shows a flow-chart of an example method 200, performed by a radio network node according to this disclosure, for enabling wireless power transfer from a PTED to a WD. The radio network node is the radio network node disclosed herein, such as radio network node 400 of FIG. 1, FIG. 5, and FIG. 6.

In one or more example methods, the method 200 comprises receiving S201, from the PTED, capability information indicative of the PTED's capability to transfer power to one or more WDs. Receiving S201 corresponds to transmitting S101 of FIG. 3 and the capability signaling 702 of FIG. 7.

In one or more example methods, the method comprises transmitting S203, to the PTED, a probing configuration for probing a channel, such as a power transfer channel. The probing configuration may comprise an information indicative of a probing sweep, such as a probing sweep, to be performed by the PTED. The probing configuration may, in one or more example methods be indicative of resources, such as time and/or frequency resources, dedicated for the probing signal, such as the probing sweep. The configuration may, in one or more example methods, comprise information configuring the PTED to perform a remote and/or autonomous probing sweep. Autonomously performing can herein be seen as the PTED generating, such as transmitting, and detecting the probing signal. The probing configuration may, in one or more example methods, comprise a criterion for a further operation, such as a wireless power transfer and/or a high power operational mode. The criterion may be a criterion for when the further operation is to be performed.

In one or more example methods, the criterion comprises a range, such as a minimum distance. The range can herein be seen as a range, such as a distance, from the PTED to the WD. In one or more example methods, the range has an exception associated with a beam configuration which is associated with the further operation, such as with the wireless power transfer and/or the high power operational mode. The beam configuration may be associated with a near field beam, such as may indicate that the further operation is to be performed with the near field beam. In other words, the PTED may be configured to transmit wireless power and/or with the high power operational mode, when the WD is within the indicated range. In one or more example methods, the criterion comprises a time, such as a time duration. The time duration may be associated with the further operation. In one or more example methods, the time may indicate a time the probing image has to be static before the further operation can be performed, and/or a duration of further operation, such as a time duration during which the power transfer and/or high power operational mode is to be activated.

In one or more example methods, the criterion comprises a reporting configuration. The reporting configuration may indicate how and/or when the PTED is to transmit the probing report, and/or what information the reporting configuration is to comprise. In one or more example methods, the reporting configuration may indicate whether the PTED is to receive an acknowledgement (ACK) from the radio network node prior to performing the further operation.

In one or more example methods, the method 200 comprises receiving S205, from the PTED, information indicative of the PTED meeting a power transfer requirement for transferring power to the WD. In one or more example methods, the information indicative of the PTED meeting the power transfer requirement may be indicative of one or more of a beam configuration for power transfer to the WD, a relative position between the WD and the PTED, the WD being in LOS of the PTED, a power measurement meeting a power transfer requirement for transferring power, a RSSI meeting a RSSI requirement and a SNR meeting a SNR requirement. The power transfer requirement may be determined by the radio network node. In one or more example methods, receiving S205 information indicative of the PTED meeting a power transfer requirement for transferring power to the WD comprises transmitting S205A one or more probing reports. The one or more probing reports may comprise information indicative of the probing result, such as information indicative of whether there are objects present in the vicinity of the PTED. The one or more probing reports may comprise different details of the probing signal sweeps, for example based on a capability of the PTED. To effectively use scarce spectrum resources, the PTED may transmit a first full probing report, and later-on, only report if there are substantial changes in a probing based measurement, such as in a measured probing image. In one or more example methods, the one or more probing reports comprise information indicating that it is “ok to perform wireless power transfer”, such as the probing meeting a probing criterion for transferring power to the WD. In one or more examples, upon the probing being indicative of objects in the vicinity of the PTED, the probing report may comprise information indicating that it is “not ok to perform wireless power transfer”, such as the probing criterion not being met. In one or more example methods, the probing criterion may be that there are no objects within a certain range from the PTED, for example in the direction of the WD to receive the power transfer, and/or that the probing image has not changed for a certain time-period. Receiving S205 corresponds to transmitting S107 of FIG. 3 and the signaling 704 of FIG. 7. Receiving S205A corresponds to transmitting S107A of FIG. 3.

In one or more example methods, the method 200 comprises allocating, such as configuring, S207 the set of resources for power transfer from the PTED to the WD. In one or more example methods, configuring S207 is based on the received capability information. The set of resources for power transfer may be a dedicated set of resources for power transfer, such as set of resources used only for power transfer.

In one or more example methods, allocating, such as configuring, S207 comprises determining S207A that the PTED meets a power transfer requirement for transferring power to the WD. Determining S207A may be based on the received information indicative of the PTED meeting the power transfer requirement for transferring power to the WD.

In one or more example methods, determining S207A comprises determining S207AA that the WD is within a power transfer distance of the PTED. This may be the case when the information indicative of the PTED meeting the power transfer requirement received from the PTED comprises information about the relative location of the WD in relation to the PTED. In one or more example methods, the radio network node may receive the position of the WD and/or the PTED from the respective device and may determine that the WD is within the power transfer distance of the PTED based on the received positions. The power transfer distance can be seen as a distance enabling power transfer, such as an efficient power transfer, to the WD.

The method 200 comprises transmitting S209, to the PTED and/or to the WD, the set of resources configured for power transfer from the PTED to the WD. Transmitting S209 the set of resources can be seen as configuring the PTED and/or the WD with the resources for power transfer. Transmitting S209 corresponds to receiving S109 of FIG. 3 and the signaling 706 of FIG. 7.

In one or more example methods, the method 200 comprises triggering S207 a power transfer from the PTED to the WD. In one or more example methods, triggering S207 comprises transmitting S207A, to the PTED, a signal to be amplified by the PTED for transferring power to the WD. In one or more example methods, triggering S207 may be performed based on the probing report, such as upon the probing report indicating that the probing criterion is met.

In one or more example methods, triggering S207 comprises transmitting S207B, to the PTED, a message triggering the PTED to generate a power transfer signal for transferring power to the WD. In one or more example methods, the message triggering the PTED to generate a power transfer signal may comprise transmitting a message indicative of an ACK. The message indicative of an ACK may be transmitted based on the probing report, such as upon the probing report indicating that the probing criterion is met.

FIG. 4 shows a block diagram of an example PTED 500 according to the disclosure. The PTED 500 comprises memory circuitry 501, processor circuitry 502, and a wireless interface 503. The PTED 500 may be configured to perform any of the methods disclosed in FIG. 2. In other words, the PTED 500 may be configured for wireless power transfer to a WD.

The PTED 500 is configured to communicate with a radio network node, such as the radio network node disclosed herein, using a wireless communication system.

The PTED 500 is configured to receive (such as, via the wireless interface 503), from a radio network node, a set of resources configured for power transfer to the WD.

The PTED 500 is configured to transmit (such as, via the wireless interface 503) a power transfer signal in the set of resources.

The wireless interface 303 is configured for wireless communications via a wireless communication system, such as a 3GPP system, such as a 3GPP system supporting one or more of: New Radio, NR, Long Term Evolution, LTE, Narrow-band IoT, NB-IoT, and Long Term Evolution-enhanced Machine Type Communication, LTE-M, and 3GPP system operated in licensed bands or unlicensed bands.

The PTED 500 is optionally configured to perform any of the operations disclosed in FIG. 2 (such as any one or more of: S101, S103, S105, S107, S107A, S109, S110, S111, S111A, S111AA, S111B). The operations of the PTED 500 may be embodied in the form of executable logic routines (for example, lines of code, software programs, etc.) that are stored on a non-transitory computer readable medium (for example, memory circuitry 501) and are executed by processor circuitry 502.

Furthermore, the operations of the PTED 500 may be considered a method that the PTED 500 is configured to carry out. Also, while the described functions and operations may be implemented in software, such functionality may also be carried out via dedicated hardware or firmware, or some combination of hardware, firmware and/or software.

Memory circuitry 501 may be one or more of: a buffer, a flash memory, a hard drive, a removable media, a volatile memory, a non-volatile memory, a random access memory (RAM), and any other suitable device. In a typical arrangement, memory circuitry 501 may include a non-volatile memory for long term data storage and a volatile memory that functions as system memory for processor circuitry 502. Memory circuitry 501 may exchange data with processor circuitry 502 over a data bus. Control lines and an address bus between memory circuitry 501 and processor circuitry 502 also may be present (not shown in FIG. 4). Memory circuitry 501 is considered a non-transitory computer readable medium.

Memory circuitry 501 may be configured to store a set of resources, a signal received from the radio network node in a part of the memory.

FIG. 5 shows a block diagram of an example radio network node 400 according to the disclosure. The radio network node 400 comprises memory circuitry 401, processor circuitry 402, and a wireless interface 403. The radio network node 400 may be configured to perform any of the methods disclosed in FIG. 3. In other words, the radio network node 400 may be configured for enabling wireless power transfer from a PTED to a WD.

The radio network node 400 is configured to communicate with a PTED, such as the PTED disclosed herein, using a wireless communication system.

The network node 400 is configured to transmit (such as, via the wireless interface 403), to the PTED, a set of resources, such as time and/or frequency resources, configured for power transfer to the WD. The set of resources may be dedicated resources for transfer of power.

The wireless interface 403 is configured for wireless communications via a wireless communication system, such as a 3GPP system, such as a 3GPP system supporting one or more of: New Radio, NR, Long Term Evolution, LTE, Narrow-band IoT, NB-IoT, and Long Term Evolution-enhanced Machine Type Communication, LTE-M, and 3GPP system operated in licensed bands or unlicensed bands.

Processor circuitry 402 is optionally configured to perform any of the operations disclosed in FIG. 3 (such as any one or more of: S201, S203, S205, S205A, S207, S207A, S207AA, S209, S211, S211A, S211B). The operations of the network node 400 may be embodied in the form of executable logic routines (for example, lines of code, software programs, etc.) that are stored on a non-transitory computer readable medium (for example, memory circuitry 401) and are executed by processor circuitry 402.

Furthermore, the operations of the network node 400 may be considered a method that the network node 400 is configured to carry out. Also, while the described functions and operations may be implemented in software, such functionality may also be carried out via dedicated hardware or firmware, or some combination of hardware, firmware and/or software.

Memory circuitry 401 may be one or more of a buffer, a flash memory, a hard drive, a removable media, a volatile memory, a non-volatile memory, a random access memory (RAM), or other suitable device. In a typical arrangement, memory circuitry 401 may include a non-volatile memory for long term data storage and a volatile memory that functions as system memory for processor circuitry 402. Memory circuitry 401 may exchange data with processor circuitry 402 over a data bus. Control lines and an address bus between memory circuitry 401 and processor circuitry 402 also may be present (not shown in FIG. 5). Memory circuitry 401 is considered a non-transitory computer readable medium.

Memory circuitry 401 may be configured to store information, such as information indicative of a set of resources, capability information, information indicative of the PTED meeting a power transfer requirement, in a part of the memory.

FIG. 6 shows a signaling diagram of an example communication 700 between a PTED 500, a radio network node 400, and a WD 300 according to this disclosure.

The PTED 500 may transmit capability signaling 702 to the radio network node 400, the capability signaling being indicative of the PTED 500 supporting wireless power transfer, such as being capable of transferring power to one or more WDs. The capability signaling 702 corresponds to the capability signaling transmitted in S101 of FIG. 2 and received in S201 of FIG. 3.

The radio network node 400 may transmit a probing configuration 703A to the PTED 500. The probing configuration 703A corresponds to the probing configuration received in S103 of FIG. 2 and transmitted in S203 of FIG. 3.

The PTED 500 may probe 703B a channel, such as a power transfer channel. The probing may be based on the probing configuration 703A. The probing 703B corresponds to the probing performed in S105 of FIG. 2.

The PTED 500 may transmit information 704 indicative of the PTED 500 meeting a power transfer requirement for transferring power to the WD 300. In one or more example methods, the information indicative of the PTED meeting a power transfer requirement for transferring power to the WD comprises one or more probing reports. The information 704 corresponds to the information indicative of the PTED meeting a power transfer requirement transmitted in S107 of FIG. 2 and received in S205 of FIG. 3.

The radio network node 400 may determine 706, such as identify and/or allocate, a resource configuration, such as a set of resources, for power transfer to a WD 300 that requires power transfer and is within a coverage range of PTED 500. The radio network node 400 may, in one or more example methods determine, for example via a positioning procedure performed by the radio network node 400 or the PTED 500, that the WD 300 is within a range of the PTED 500 that allows for power transfer from the PTED 500. In one or more example methods, the radio network node 400 may determine 706 that the WD 300 is within a coverage range of the PTED 500 based on the information 704. In one or more example methods, the radio network node may determine that the WD is within the coverage area of the PTED 500 based on a beam configuration, such as a near field set of beams, of the PTED 500. The beam configuration, such as the near field set of beams, of the PTED 500 may indicate that a power transfer is possible (such as a subset of all beams being feasible for power transfer). The beam configuration may be comprised in the information 704 received from the CED 500. Determining 706 corresponds to allocating S207 of FIG. 3.

The radio network node 400 transmits the resource configuration 708, such as the set of resources, for power transfer to PTED 500 and/or the WD 300. The resources configuration 708 correspond to the resources received in S109 of FIG. 2 and transmitted in S209 of FIG. 3.

The PTED 500 transfers power 710 to the WD 300 in the resources 708 received from the radio network node 400. The PTED 500 may enter the dedicated operational mode for power transfer. The PTED 500 may enter a high power and/or a high gain mode and transmit the power signal in the configured resources. The high power and/or high gain mode can be seen as a power transfer mode in which a normal power and/or gain, such as a power and/or gain used for transmission of information, is exceeded. The power signal may be self-generated by the PTED 500 and/or may be an amplification of a signal received from the radio network node 400. The PTED 500 may amplify the signal by applying an amplification mode, such as an ultra-high amplification mode.

In one or more example methods, the PTED 500 may convey information 712, such as data, in a second set of resources not associated with power transfer.

Examples of methods and products (power transfer enhancing device and network node) according to the disclosure are set out in the following items:
Item 1. A method, performed by a power transfer enhancing device, PTED, for wireless power transfer to a wireless device, WD, the method comprising:
   receiving (S109), from a radio network node, a set of resources configured for power transfer to the WD, and
   transmitting (S111) a power transfer signal in the set of resources.
Item 2. The method according to Item 1, wherein the method comprises:
   transmitting (S101), to the radio network node, capability information indicative of the PTED's capability to transfer power to one or more WD(s).
Item 3. The method according to Item 1 or 2, wherein the method comprises:
   transmitting (S107), to the radio network node, information indicative of the PTED meeting a power transfer requirement for transferring power to the WD.
Item 4. The method according to any one of the previous Items, wherein the power transfer signal is transmitted using a dedicated operational mode of the PTED.
Item 5. The method according to any one of the previous Items, wherein transmitting (S111) comprises generating (S111A) the power transfer signal using a pre-determined or pre-configured waveform for wireless power transfer.
Item 6. The method according to any one of the Items 1 to 4, wherein transmitting (S111) the power transfer signal comprises amplifying (S111B) a signal received from the radio network node.
Item 7. The method of Item 6, wherein the signal received from the radio network node is a dedicated power transfer signal.
Item 8. The method according to Item 5, wherein generating (S111A) the signal comprises ceasing (S111AA) to relay a signal received at a receiver of the PTED to increase the power level of the transmitted power transfer signal.
Item 9. The method according to any one of the previous Items, wherein transmitting (S111) the power transfer signal is performed upon receiving a trigger from the radio network node.
Item 10. The method according to any one of the previous Items, wherein the method comprises receiving (S103), from the radio network node, a probing configuration.
Item 11. The method according to any one of the previous Items, wherein the method comprises probing (S105) a channel.
Item 12. The method according to Item 11, wherein transmitting (S111) the power transfer signal is performed based on the probing (S105) of the channel.
Item 13. A method, performed by a radio network node, for enabling wireless power transfer from a power transfer enhancing device, PTED, to a WD, the method comprising:
   transmitting (S209), to the PTED, a set of resources configured for power transfer to the WD.
Item 14. The method according to Item 13, wherein the method comprises: receiving (S201), from the PTED, capability information indicative of the PTED's capability to transfer power to one or more WDs.
Item 15. The method according to Item 13 or 14, wherein the method comprises:
   receiving (S205), from the PTED, information indicative of the PTED meeting a power transfer requirement for transferring power to the WD.
Item 16. The method according to any one of Items 13 to 15, wherein the method comprises:
   allocating (S207) the set of resources for power transfer from the PTED to the WD.
Item 17. The method according to Item 16, wherein allocating (S207) is based on one or more of the received capability information and/or the received information indicative of the PTED meeting a power transfer requirement.
Item 18. The method according to Item 17, wherein allocating (S207) comprises determining (S207A) that the PTED meets a power transfer requirement for transferring power to the WD.
Item 19. The method according to Item 18, wherein determining (S207A) comprises determining (S207AA) that the WD is within a power transfer distance of the PTED.
Item 20. The method according to Item 15 and any one of Items 18 to 19, wherein determining (S207A) is based on the received information indicative of the PTED meeting the power transfer requirement for transferring power to the WD.
Item 21. The method according to any one of Items 13 to 20, wherein the method comprises:
   triggering (S211) a power transfer from the PTED to the WD.
Item 22. The method according to Item 21, wherein triggering (S211) comprises: transmitting (S211A), to the PTED, a signal to be amplified by the PTED for transferring power to the WD.
Item 23. the method according to Item 21, wherein triggering (S211) comprises:
   transmitting (S211B), to the PTED, a message triggering the PTED to generate a power transfer signal for transferring power to the WD.
Item 24. A power transfer enhancing device, PTED, comprising memory circuitry, processor circuitry, and a wireless interface, wherein the PTED is configured to perform any of the methods according to any of Items 1-12.
Item 25. A radio network node comprising memory circuitry, processor circuitry, and a wireless interface, wherein the radio network node is configured to perform any of the methods according to any of Items 13-23.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-6 comprise some circuitries or operations which are illustrated with a solid line and some circuitries, components, features, or operations which are illustrated with a dashed line. Circuitries or operations which are comprised in a solid line are circuitries, components, features or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented. Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination.

It is to be noted that the word “comprising” does not necessarily exclude the presence of other elements or steps than those listed. It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed by a power transfer enhancing device (PTED), for wireless power transfer to a wireless device (WD), the method comprising:
receiving, from a radio network node, a set of resources configured for power transfer to the WD, and
transmitting a power transfer signal in the set of resources.

2. The method according to claim 1, wherein the method comprises:
transmitting, to the radio network node, capability information indicative of the PTED's capability to transfer power to one or more WD(s).

3. The method according to claim 1, wherein the method comprises:
transmitting to the radio network node, information indicative of the PTED meeting a power transfer requirement for transferring power to the WD.

4. The method according to claim 1, wherein the power transfer signal is transmitted using a dedicated operational mode of the PTED.

5. The method according to claim 1, wherein transmitting comprises generating the power transfer signal using a pre-determined or pre-configured waveform for wireless power transfer.

6. The method according to claim 1, wherein transmitting the power transfer signal comprises amplifying a signal received from the radio network node.

7. The method according to claim 6, wherein the signal received from the radio network node is a dedicated power transfer signal.

8. The method according to claim 5, wherein generating the signal comprises ceasing to relay a signal received at a receiver of the PTED to increase the power level of the transmitted power transfer signal.

9. The method according to claim 1, where transmitting the power transfer signal is performed upon receiving a trigger from the radio network node.

10. The method according to claim 1, wherein the method comprises receiving from the radio network node, a probing configuration.

11. The method according to claim 1, wherein the method comprises probing a channel and wherein transmitting the power transfer signal is performed based on the probing of the channel.

12. (canceled)

13. A method, performed by a radio network node, for enabling wireless power transfer from a power transfer enhancing device (PTED) to a WD, the method comprising:
transmitting, to the PTED, a set of resources configured for power transfer to the WD.

14. The method according to claim 13, wherein the method comprises:
receiving, from the PTED, capability information indicative of the PTED's capability to transfer power to one or more WDs.

15. The method according to claim 13, wherein the method comprises:
receiving, from the PTED, information indicative of the PTED meeting a power transfer requirement for transferring power to the WD.

16. The method according to claim 13, wherein the method comprises:
allocating the set of resources for power transfer from the PTED to the WD.

17. The method according to claim 16, wherein allocating is based on one or more of the received capability information and/or the received information indicative of the PTED meeting a power transfer requirement.

18. The method according to claim 17, wherein allocating comprises determining that the PTED meets a power transfer requirement for transferring power to the WD, and wherein determining comprises determining that the WD is within a power transfer distance of the PTED.

19. (canceled)

20. The method according to claim 15, wherein allocating comprises determining that the PTED meets a power transfer requirement for transferring power to the WD, and wherein determining is based on the received information indicative of the PTED meeting the power transfer requirement for transferring power to the WD.

21. The method according to claim 13, wherein the method comprises:
triggering a power transfer from the PTED to the WD, and
wherein triggering comprises transmitting, to the PTED, a signal to be amplified by the PTED for transferring power to the WD.

22. (canceled)

23. The method according to claim 13, wherein the method comprises:
triggering a power transfer from the PTED to the WD, and wherein triggering comprises:
transmitting, to the PTED, a message triggering the PTED to generate a power transfer signal for transferring power to the WD.

24-25. (canceled)
